(19) United States
(12) Patent Application Publication
(10) Pub. No.: US 2009/0135271 A1
(43) Pub. Date: May 28, 2009

(54) IMAGE TAKING APPARATUS AND IMAGE RECORDER

(75) Inventor: Haruhisa KURANE, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/272,977

(22) Filed: Nov. 18, 2008

(30) Foreign Application Priority Data
Nov. 27, 2007 (JP) 2007-305467

(51) Int. Cl. H04N 5/228

(52) U.S. Cl. 348/222.1

(57) ABSTRACT

An image taking apparatus includes: a photoelectric conversion unit including a plurality of photoelectric conversion elements, the photoelectric conversion elements disposed in a two-dimensional matrix, the photoelectric conversion elements converting received light into electric charge and accumulating the electric charge; an image sensor having a function of controlling an exposure time of each of the photoelectric conversion elements of the photoelectric conversion unit on a line-by-line basis; an area division unit for logically dividing the photoelectric conversion unit into an N number of uniform areas on the basis of information related to a taken image of a subject, each of the uniform areas including a line having some of the photoelectric conversion elements, N being a natural number of two or more; an interlaced scanning unit for scanning the photoelectric conversion elements in the first to N-th areas by M lines starting with a predetermined line in a predetermined area of the first to N-th areas while changing an area to be scanned to another area in a predetermined order each time the M lines are scanned, M being a natural number of one or more; and a pixel signal reading unit for reading, from each of the photoelectric conversion elements scanned by the interlaced scanning unit, a pixel signal including an electric signal corresponding to an amount of electric charge accumulated in each photoelectric conversion element.

### BACKGROUND

1. Technical Field

Several aspects of the present invention relate to an image sensor that is allowed to expose a photoelectric conversion element to light on a line-by-line basis. In particular, the invention relates to an image taking apparatus and an image recorder suitable for accurately taking an image of a subject that lights up and lights out cyclically when emitting light.

2. Related Art

Recently, a drive recorder has been mounted on an automobile. This apparatus is intended to image and record the situation in the event of an accident to find out the cause of the accident. One of key functions of a drive recorder is to record the state of a traffic signal at a place where an accident is likely to occur, such as an intersection.

Incidentally, a solid-state light source such as a light-emitting diode (LED) has recently been used in a traffic signal (on grounds that a traffic signal using a solid-state light source is easily recognized even if the solid-state light source is exposed to sunlight, that a solid-state light source is efficient, and that a solid-state light source has a long life, and the like). A solid-state light source is direct-current driven or modulation-driven at an arbitrary frequency, unlike a traditional fluorescent tube or lamp. In the case of modulation drive, there is a high degree of freedom in setting the flashing frequency and the flashing frequency may be set to an arbitrary frequency depending on a target to which the flashing frequency is to be applied. If an LED is used in a traffic signal, the LED is typically modulation-driven (flashes) at a speed such that human eyes cannot perceive the modulation while borrowing a power supply mechanism of a traditional lamp.

Among such technologies related to LED dimming using an alternating current power supply is an LED dimming controller described in JP-A-2005-524960. Also, technologies related to illumination using an LED light source include a lighting system described in JP-A-2005-502167. In both the related-art examples, an LED is modulation-driven at a speed such that human eyes cannot perceive the modulation.

Incidentally, if an image of a solid-state light source is taken by a camera using a charge coupled device (CCD) image sensor, it may not be determined from the taken image whether the light source is lighting up or lighting out. This is because the light source is flashing (at an invisible speed) while the light source is actually emitting light. Since the CCD performs an exposure using a global (electronic) shutter system, the above-mentioned phenomenon occurs depending on the relations between the timings at which the solid-state light source lights up and lights out and the timings at which an exposure is performed. More specifically, if an image of the solid-state light source is taken under a bright environment, the automatic exposure control mechanism of the CCD works. This reduces the exposure time (shutter speed). For example, as shown in FIG. 11, if an exposure is performed when a rapidly flashing traffic signal is lighting out, the traffic signal looks as if it were lighting out, although it is emitting light.

In FIG. 12, an “exposure invalid time (dead time)” refers to a period during which no exposure is performed. Even if a traffic signal lights up during this period, the traffic signal is not detected as a signal.

Next, a case is considered where an image of a solid-state light source is taken by a camera using a complementary metal oxide semiconductor (CMOS) image sensor. A CMOS image sensor typically employs the rolling shutter system as an exposure/shutter system and is allowed to perform an exposure on a line-by-line basis unlike a CCD image sensor. However, since lines are sequentially exposed to light one by one in a CMOS image sensor, an exposure is performed when a flashing subject is lighting out, depending on the position where an image of the subject is taken. This causes a phenomenon similar to that in a case where a CCD image sensor is used.

For example, as shown in FIG. 13, lines are sequentially exposed to light starting with the first line and pixel signals are read out using the rolling shutter system. In the area of Line 1 to 10, the traffic signal appears to be lighting out, although it is emitting light, like a case where a CCD image sensor is used. In the area of Line 11 to 20, lines are exposed to light when the traffic signal is lighting up. Therefore, if an image of the traffic signal is taken in the area of Line 11 to 20, an image of the traffic signal that is emitting light is accurately taken. In FIG. 13, the exposure invalid time is similar to that in FIG. 12 and “↑” indicates a timing when a pixel signal is read out.

Among phenomena attributable to an exposure/shutter operation performed using the rolling shutter system is flicker (detected as horizontal stripes) caused when an image of a subject is taken under indoor illumination using a florescent light. Methods for solving this problem include an image taking apparatus described in JP-A-2002-94883. In this related-art example, attention is paid to a high degree of freedom in designing a circuit of a CMOS image sensor and a problem solving means using interlaced scanning is proposed.

In the above-mentioned related-art example, there is detailed description abut the elimination of temporal continuity between lines using interlaced scanning for the purpose of reducing flicker. However, there is no description about a specific exposure timing (interlaced step) for accurately taking an image of a flashing subject such as an LED traffic signal under a condition in which the exposure time is extremely short, such as outdoors in fine weather.

### SUMMARY

An advantage of the invention is to provide an image taking apparatus and an image recorder suitable for accurately taking an image of a subject that lights up and lights out cyclically when emitting light.

According to a first aspect of the invention, an image taking apparatus includes: a photoelectric conversion unit including a plurality of photoelectric conversion elements, the photoelectric conversion elements disposed in a two-dimensional matrix, the photoelectric conversion elements converting received light into electric charge and accumulating the electric charge; an image sensor having a function of controlling an exposure time of each of the photoelectric conversion elements of the photoelectric conversion unit on a line-by-line basis; an area division unit for logically dividing the photoelectric conversion unit into an N number (N is a natural number of two or more) of uniform areas on the basis of information related to a taken image of a subject, each of the uniform areas including a line having some of the photoelectric conversion elements; an interlaced scanning unit for scanning the photoelectric conversion elements in the first to N-th areas by M lines (M is a natural number of one or more) starting with a predetermined line in a predetermined area of the first to N-th areas in each frame while changing an area to be scanned to another area in a predetermined order each time the M lines are scanned; a pixel signal reading unit for reading, from each of the photoelectric conversion elements scanned by the interlaced scanning unit, a pixel signal including an electric signal corresponding to an amount of electric charge accumulated in each photoelectric conversion element; and a scanning timing control unit for controlling a timing at which the interlaced scanning unit performs scanning, on the basis of a time of each frame and an exposure time set for each of the lines.

By employing such a configuration, the area division unit logically divides the photoelectric conversion unit into the N number of uniform areas (first to N-th areas) and the interlaced scanning unit scans lines in each area by M lines starting with a predetermined line in a predetermined area of the first to N-th areas. In this case, an area to be scanned is changed to another area in a predetermined order each time M lines are scanned in any one of the areas. For example, lines are scanned by M lines starting with the top line in a predetermined area while changing an area to be scanned to another area in the order of disposition of the first to N-th areas each time M lines are scanned.

On the other hand, if a line including some of the photoelectric conversion elements is scanned, the pixel signal reading unit reads a pixel signal corresponding to the amount of accumulated electric charge from each of the photoelectric conversion elements included in the scanned line.

Thus, pixel signals are read out at equal intervals in each area almost over one frame period. As a result, there is advantageously increased a probability that if a flashing solid-state light source lights up and lights out in one frame, an image of the solid-state light source in a lighting-up state is taken in one or some of lines including photoelectric conversion elements in the photoelectric conversion unit. In particular, by dividing the photoelectric conversion unit into a proper number of areas using the area division unit, there is further increased the probability that an image of the solid-state light source in a lighting-up state is taken.

The above-mentioned “photoelectric conversion unit” is formed using CMOS technology. Among image sensors using CMOS technology is a threshold voltage modulation image sensor (VMIS).

Also, the above-mentioned “function of controlling the exposure time” refers to, for example, a known electronic shutter function such as the focal plane shutter (rolling shutter) system employed by CMOS image sensors.

Also, the above-mentioned “information related to a taken image of a subject” refers to, for example, one frame period, the exposure time of each line, and information about the flashing cycle of a subject in a case where the subject is a flashing solid-state light source.

Also, if the configuration of color filters is of sub-pixel type as shown in FIG. 14A, the M is set to one so as to obtain information about the color of a subject. On the other hand, if the configuration of color filters is of Bayer array type as shown in FIG. 14B, the M is set to two so as to obtain color components of red and blue. Instead of the color filter configuration, the M may be set in accordance with other conditions. For example, the number of lines may be increased if the resolution is high (the number of pixels is large).

The image taking apparatus according to the first aspect of the invention may further include a normal scanning unit for sequentially scanning the photoelectric conversion elements of the photoelectric conversion unit by the M lines. In this case, if the exposure time of the line is less than half the frame period, the area division unit may logically divide the photoelectric conversion unit into the N number of areas and the interlaced scanning unit scans the photoelectric conversion elements, and if the exposure time of the line is half or more the frame period, the normal scanning unit may scan the photoelectric conversion elements and the pixel signal reading unit may read the pixel signal from each of the photoelectric conversion elements scanned by the normal scanning unit.

By employing such a configuration, if the exposure time is half or more of one frame period, the normal scanning unit scans the photoelectric conversion elements. In contrast, if the exposure time is less than half one frame period, the interlaced scanning unit scans the photoelectric conversion elements. Thus, when interlaced scanning need not be performed, the load imposed on the interlaced scanning unit is advantageously reduced.

That is, if a flashing solid-state light source lights up and lights out in one frame and if the exposure time is half or more of one frame period, the exposure times of a relatively wide range of lines in the photoelectric conversion unit overlap the period during which the solid-state light source lights up even if lines are sequentially scanned one by one without performing interlaced scanning. As a result, an image of the solid-state light source in a lighting-up state is taken almost certainly with accuracy. Therefore, in such a case, normal scanning is performed.

On the other hand, if normal scanning is performed when the exposure time is less than half one frame period, the number of lines whose exposure time does not overlap the period during which the solid-state light source lights up is larger than that in a case where the exposure time is half or more of one frame period. As a result, there is increased a probability that an image of the flashing solid-state light source in a light-emitting state is not accurately taken depending on the position at which an image of the solid-state light source is taken. Therefore, in such a case, interlaced scanning is performed.

In the image taking apparatus according to the first aspect of the invention, the area division unit may logically divide the photoelectric conversion unit into the N number of areas on the basis of a result of division of the frame period by the exposure time of the line.

By employing such a configuration, the photoelectric conversion unit is divided into a proper number of areas in accordance with the exposure time. As a result, the photoelectric conversion unit is advantageously uniformly divided into the number of areas such that interlaced scanning is reliably performed and that an image of a flashing solid-state light source in a lighting-up state is accurately taken.

The image taking apparatus according to the first aspect of the invention may further include a cycle information acquisition unit for acquiring information about a cycle of lighting up and lighting out of a subject, the subject emitting light while lighting up and lighting out cyclically. In this case, if an image taking target includes the subject, the area division unit may logically divide the photoelectric conversion unit into the N number of areas on the basis of the cycle information acquired by the cycle information acquisition unit.

By employing such a configuration, the flashing cycle of a flashing subject is known. As a result, if a flashing solid-state light source lights up and lights out in one frame, the photoelectric conversion unit is advantageously divided into a proper number of areas so that an image of the solid-state light source in a lighting-up state is taken in one or some of lines including the photoelectric conversion elements in the photoelectric conversion unit.

In the image taking apparatus according to the first aspect of the invention, the area division unit may logically divide the photoelectric conversion unit into the N number of areas on the basis of a result obtained by: dividing a cycle time of lighting up and lighting out of the subject, by a time giving a cycle of a frame; multiplying a result of the division by a total number of lines included in the photoelectric conversion unit; and dividing a result of the multiplication by two.

By employing such a configuration, the photoelectric conversion unit is logically divided into multiple uniform areas regardless of how long the exposure time is. As a result, even if the exposure time is extremely reduced due to the image taking environment such as outdoors, fine weather, or backlight, the photoelectric conversion unit is advantageously divided into the number of areas such that an image of a flashing solid-state light source in a lighting-up state is taken almost accurately.

The image taking apparatus according to the first aspect of the invention may further include an image data generation unit for generating image data on the basis of a pixel signal read by the pixel signal reading unit and an image data storage unit for storing the image data.

By employing such a configuration, an operation and an advantage similar to those of the above-mentioned image taking apparatus are obtained. Also, image data is generated on the basis of a read pixel signal and the generated image data is stored. Accordingly, the image data can be used for various applications.

An image recorder according to a second aspect of the invention includes: the image taking apparatus according to the first aspect of the invention; an image recorder for recording image data over a plurality of continuous frames, the image data being obtained by taking an image of a subject using the image taking apparatus; and an image data output unit for outputting the image data recorded in the image recording unit.

By employing such a configuration, an operation and an advantage similar to those of the image taking apparatus according to the first aspect of the invention are obtained. Also, image data over continuous multiple frames obtained by taking an image of a subject is recorded. For example, if the image recorder is mounted on a vehicle as a drive recorder, image data in which an image of the state of a traffic signal in the event of an accident has been taken accurately can be recorded.

### BRIEF DESCRIPTION OF THE DRAWINGS

The invention will be described with reference to the accompanying drawings, wherein like reference numerals designate like elements.

FIG. 1 is a block diagram showing an outline configuration of an image taking system 1 according to a first embodiment of the invention.

FIG. 2 is a block diagram showing an internal configuration of an image taking unit 11.

FIG. 3 is a block diagram showing an internal configuration of a scanning line scanner 54.

FIG. 4 is a diagram showing an example of exposure of each pixel and reading of a pixel signal from each pixel on a line-by-line basis in a light receiving area of a sensor cell array 56.

FIG. 5 is a block diagram showing an internal configuration of an image generation unit 12.

FIG. 6 is a diagram showing an example in which a light receiving area is logically divided.

FIG. 7 is a diagram showing an example of reset timings and pixel signal readout timings during interlaced scanning.

FIG. 8 is a diagram showing relations between exposure times and pixel signal readout timings in one frame period during interlaced scanning.

FIG. 9 is a drawing showing an example of a taken image.

FIG. 10 is a diagram showing an example of exposure timings and read timings with respect to the image shown in FIG. 9 during interlaced scanning.

FIG. 11 is a diagram showing exposure times and pixel signal readout timings in one frame period in a case where interlaced scanning is performed using an area division method according to a second embodiment of the invention.

FIG. 12 is a diagram showing relations between exposure times and pixel signal readout timings in one frame period in a case where a related-art CCD image sensor is used.

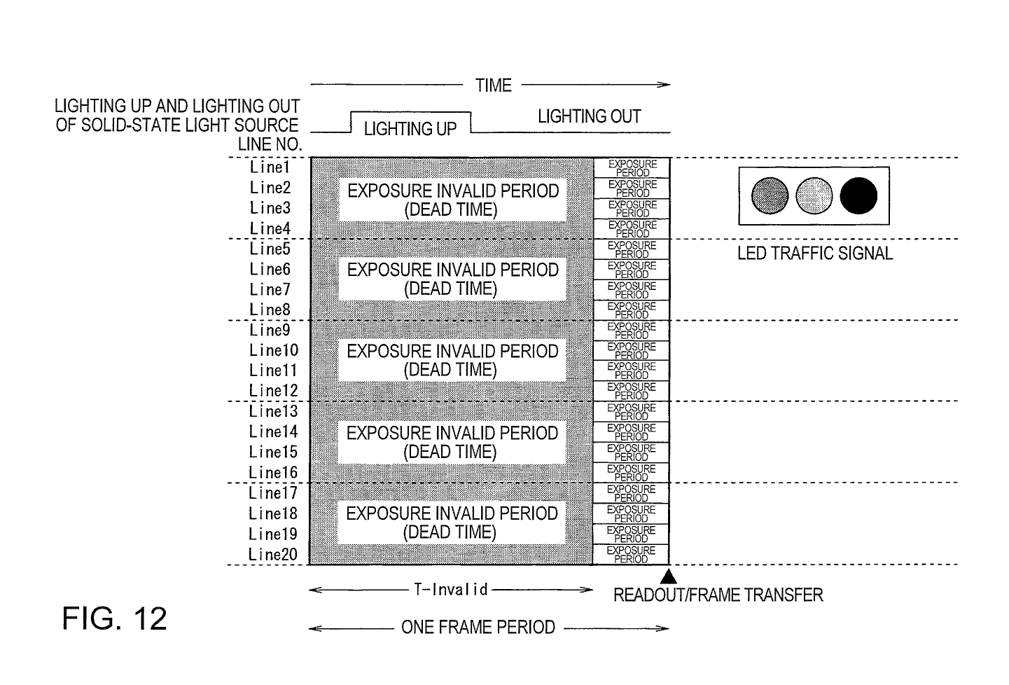

FIG. 13 is a diagram showing relations between exposure times and pixel signal readout timings in one frame period in a case where a related-art CMOS image sensor is used.

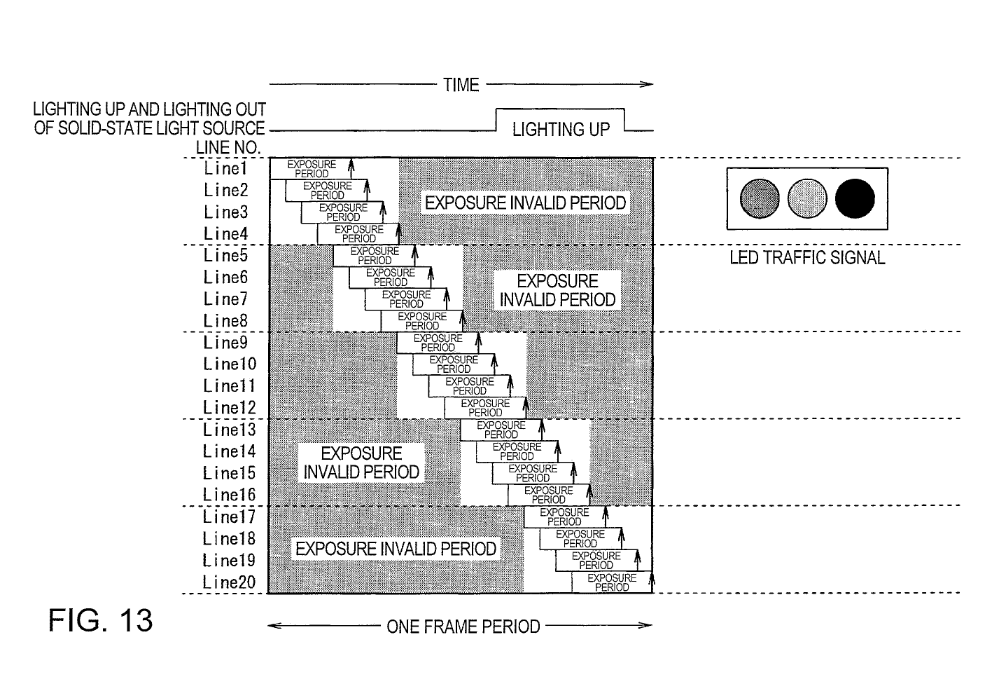

FIGS. 14A and 14B are diagrams showing examples of a method for disposing color filters with respect to pixels.

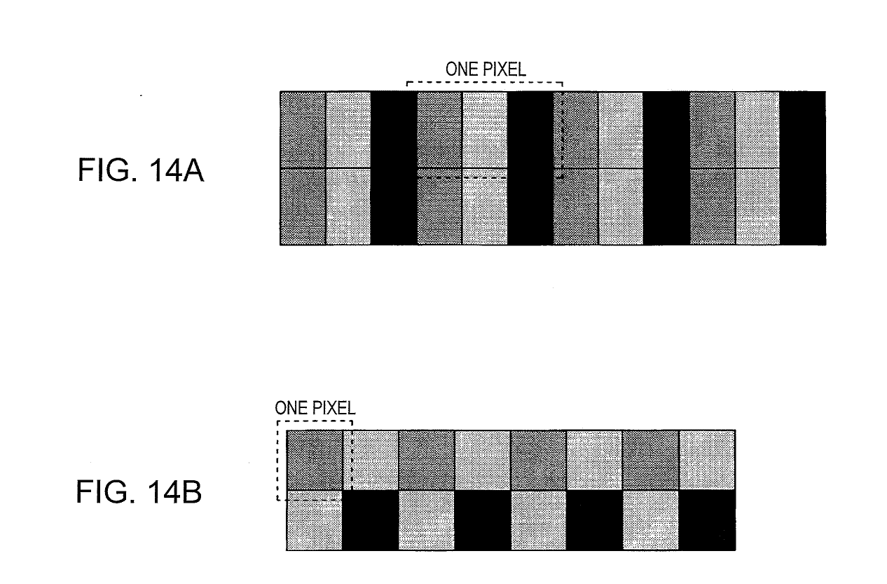

### DESCRIPTION OF EXEMPLARY EMBODIMENTS

### First Embodiment

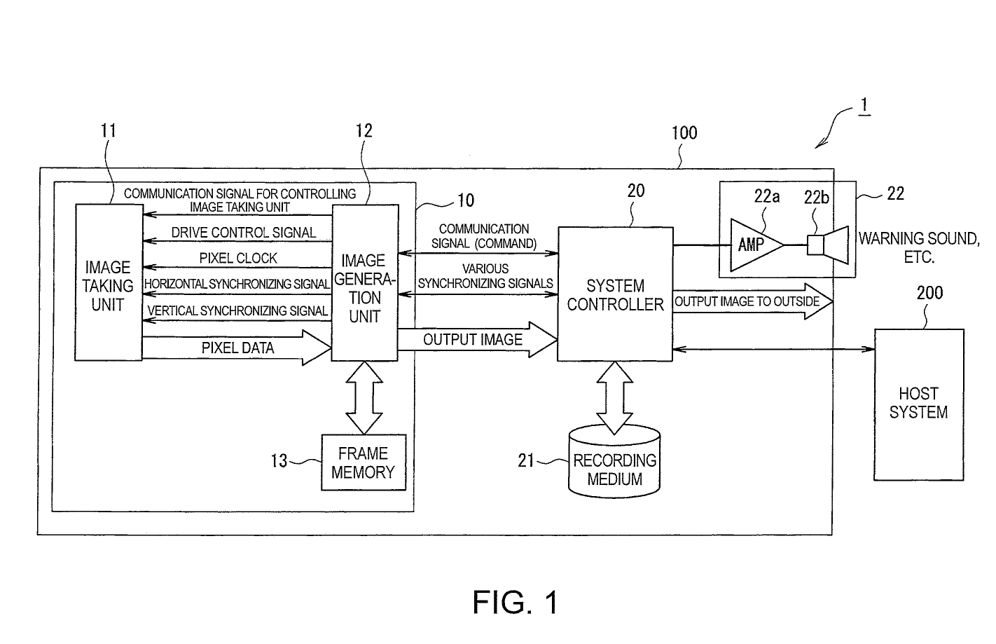

Now, an image taking apparatus and an image recorder according to a first embodiment of the invention will be described with reference to the accompanying drawings. FIGS. 1 to 10 are diagrams showing the image taking apparatus and image recorder according to this embodiment.

Referring now to FIG. 1, an outline configuration of an image taking system 1 according to this embodiment will be described. FIG. 1 is a block diagram showing an outline configuration of the image taking system 1 according to this embodiment. As shown in FIG. 1, the image taking system 1 includes an image recorder 100 and a host system 200. The image recorder 100 and host system 200 are coupled to each other so as to communicate data to each other.

The image recorder 100 includes an image taking apparatus 10 for taking an image of a subject, a system controller 20 for recording image data generated by the image taking apparatus 10 and determining information about interlaced scanning, a recording medium 21 for recording the image data, and a sound output unit 22 for outputting a warning sound or the like in accordance with an instruction given by the system controller 20.

The image taking apparatus 10 includes an image taking unit 11 including a CMOS sensor cell array (image sensor), an image generation unit 12 for generating image data for each frame on the basis of a pixel signal read from the sensor cell array, and a frame memory 13 for storing the image data.

The system controller 20 outputs commands for controlling operations of the image taking unit 11 and image generation unit 12 to the image generation unit 12, as well as to the image taking unit 11 via the image generation unit 12.

Specifically, the system controller 20 determines an exposure time, whether interlaced-scanning is performed, a step width W (W is a natural number of two or more) in a case where interlaced-scanning is performed (that is, a width W of a division area to be scanned), the number M (M is a natural number of one or more) of scanning lines in a division area, and the like on the basis of the image data from the image generation unit 12 and image taking conditions (e.g., the type of a subject (e.g., whether the subject is a flashing light source), exposure conditions, a frame period, the configuration of color filters, etc.), and outputs commands including these pieces of information.

Here, “interlaced-scanning” refers to a light receiving area scanning method in which a pixel area (light receiving area) including the total number FL (FL is a natural number of four or more) of lines in the sensor cell array included in the image taking unit 1 is logically divided into an N (N is a natural number of two or more) number of uniform areas (first to N-th areas) each including lines, M lines in a predetermined area among the first to N-th areas are scanned starting with the top line in the area, and an area to be scanned is changed to another area each time M lines are scanned.

Also, the system controller 20 transmits image data inputted from the image generation unit 12 in each frame or image data recorded in the recording medium 21 to the host system 200.

Also, the system controller 20 controls the sound output unit 22 in accordance with an instruction from the host system 200 so that the sound output unit 22 outputs a warning sound, a voice message, etc.

The recording medium 21 is a recording medium with a relatively large capacity, such as a hard disk drive (HDD) and records image data generated by the image generation unit 12 in accordance with a recording request from the system controller 20.

The sound output unit 22 includes an AMP 22a and a speaker 22b and, in accordance with an instruction from the system controller 20, amplifies a warning sound, a voice message, or the like using the AMP 22a and outputs the amplified sound from the speaker 22b.

The host system 200 analyzes an image taken by the image taking unit 11 on the basis of image data over continuous multiple frames from the system controller 20. For example, the host system 200 determines whether the image contains a rapidly flashing solid-state light source. If the image contains such a solid-state light source, the host system 200 determines whether the solid-state light source is emitting light or with what color it is emitting light.

Also, if the image recorder 100 is mounted on a vehicle and if the host system 200 determines that the vehicle is put under a dangerous situation on the basis of a analytical result of image data, the host system 200 gives, to the system controller 20, an instruction for causing the sound output unit 22 to output a warning sound or the like.

Also, if the solid-state light source is a flashing LED traffic signal, the host system 200 gives, to the system controller 20, an instruction for causing the sound output unit 22 to output a voice massage indicating a result of a determination as described above, such as a determination whether the LED traffic signal is emitting light.

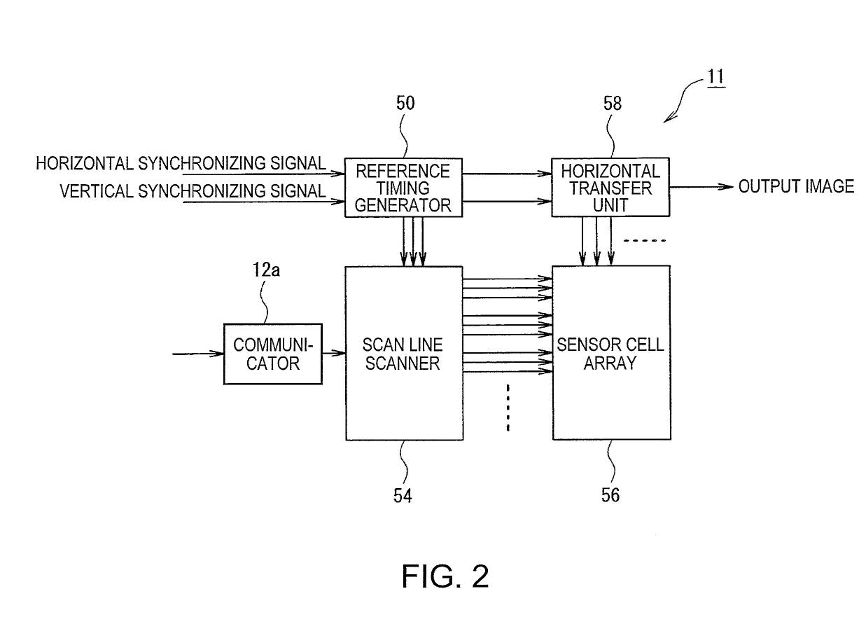

Next, an internal configuration of the image taking unit 11 included in the image taking apparatus 10 will be described with reference to FIG. 2. FIG. 2 is a block diagram showing an internal configuration of the image taking unit 11.

For convenience sake, assume that the image taking unit 11 according to this embodiment employs the sub-pixel system as the color filter array system and the scanning line number M of the image taking unit 11 is “1.” If the color filter array is a Bayer array, the scanning line number M may is “2” so that lines are scanned by two lines in each area.

As shown in FIG. 2, the image taking unit 11 includes a reference timing generator 50, a scanning line scanner 54, and a horizontal transfer unit 58.

The reference timing generator 50 generates a reference timing signal on the basis of a vertical synchronizing signal and a horizontal synchronizing signal from the image generation unit 12 and outputs the generated reference timing signal to the scanning line scanner 54.

The scanning line scanner 54 generates a reset line selection signal for enabling a line to be reset on the basis of various signals from the reference timing generator 50 and the image generation unit 12. Then, the scanning line scanner 54 outputs the generated reset line selection signal to the sensor cell array 56.

Also, the scanning line scanner 54 generates a readout line selection signal for enabling a line that has been reset and then has accumulated electric charge during a set exposure time, as a line from which a pixel signal is to be read. Then, the scanning line scanner 54 outputs the generated readout line selection signal to the sensor cell array 56.

The sensor cell array 56 includes a light receiving area formed using the CMOS technology and having a configuration in which multiple sensor cells (pixels) including light reception elements (photodiodes, etc.) are disposed in a two-dimensional matrix. In the sensor cell array 56, a common address line, a common reset line, and a common readout line are coupled to lines including pixels.

Also, in the sensor cell array 56, various drive signals (selection signals) are transmitted to sensor cells included in each line via the above-mentioned three control lines. When the address line and readout line are enabled, accumulated electric charge (pixel signal) is transferred to the horizontal transfer unit 58 via a signal line.

The image taking unit 11 includes an image taking lens (not shown) and collects light from a subject on the sensor cell array 56 via the image taking lens and accumulates electric charge on pixels in the sensor cell array 56 in accordance with the amount of the collected light.

The sensor cell array 56 thus configured enables (selects) a line including pixels to be reset or from which a pixel signal is to be read, using the address line on the basis of a selection signal provided from the scanning line scanner 54. Then, the sensor cell array 56 inputs signals for instructing reset operations into these pixels via the reset line or inputs signals for instructing transfer of accumulated electric charge into these pixels via the readout line. If signals for instructing reset operations are inputted into these pixels, there pixels are reset; if signals for instructing transfer of accumulated electric charge are inputted into these pixels, the accumulated electric charge is transferred from these pixels to the horizontal transfer unit 58 via a signal line.

The horizontal transfer unit 58 A/D-converts data (hereafter referred to as “pixel signal data”) about pixel signals (analog signals) read from the pixels included in the sensor cell array 56 and outputs the resultant data to the image generation unit 12 in serial on a line-by-line basis. The detailed configuration of the horizontal transfer unit 58 will be described later.

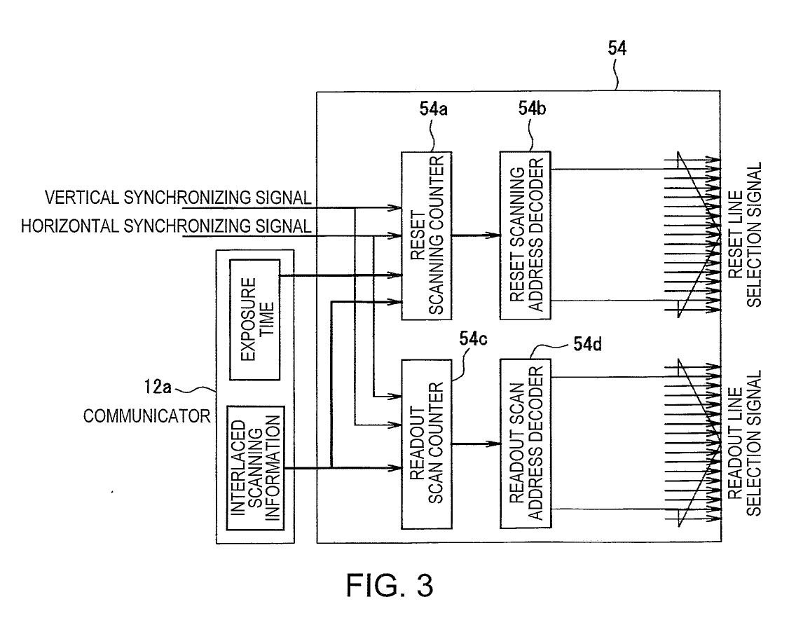

Referring now to FIG. 3, an internal configuration of the scanning line scanner 54 will be described. FIG. 3 is a block diagram showing an internal configuration of the scanning line scanner 54.

As shown in FIG. 3, the scanning line scanner 54 includes a reset scanning counter 54a, a reset scanning address decoder 54b, a readout scanning counter 54c, and a read scanning address decoder 54d.

The reset scanning counter 54a counts up the line number on the basis of information included in a vertical synchronizing signal, a horizontal synchronizing signal, and a communication signal for controlling the image taking unit from the image generation unit 12. Here, the value counted by the reset scanning counter 54a corresponds to the line number of a line including pixels in the sensor cell array 56. The information included in the communication signal for controlling the image taking unit is written into an internal register of the image taking unit 11.

Specifically, on the basis of information (stored in a register) indicating whether interlaced scanning is performed included in the communication signal for controlling the image taking unit sent from the image generation unit 12, the reset scanning counter 54a performs a counting operation for interlaced scanning if interlaced scanning is performed; it performs a counting operation for normal scanning if interlaced scanning is not performed.

If a counting operation for interlaced scanning is performed, the reset scanning counter 54a counts up the line number starting with the initial value of the counter using the step width W as a count-up width (that is, in increments of W) on the basis of information about the step width (area width) W and the scanning line number M (=1) included in the communication signal for controlling the image taking unit. Then, the reset scanning counter 54a outputs each counted value (including the initial value) to the reset scanning address decoder 54b.

On the other hand, if a counting operation for normal scanning is performed, the reset scanning counter 54a counts up the line number one by one starting with the initial value of the counter and outputs each counted value to the reset scanning address decoder 54b.

An arbitrary starting line number may be set on the basis of the communication signal for controlling the image taking unit so that the reset scanning counter 54a counts up the line number starting with the starting line number.

The counted value circulates among the line numbers from the smallest line number (e.g., the number of the lowest line in the light receiving area) to the largest line number (e.g., the number of the highest line in the light receiving area). For example, if the reset scanning counter 54a counts up the lines one by one starting with the smallest line number, reaches the largest line number, and then counts up the line number one by one, the counted value is reset and returns to the smallest line number (e.g., “1”). The same goes for the readout scanning counter 54c.

The reset scanning address decoder 54b generates a reset line selection signal for selecting and enabling, as a “reset line R”, a line with the line number outputted from the reset scanning address decoder 54b and outputs the generated reset line selection signal to the sensor cell array 56. As a result, only the selection line is enabled and other lines are disabled.

The readout scanning counter 54c repeats a counting-up operation similar to that performed by the reset scanning counter 54a on the basis of information (stored in a register) included in a vertical synchronizing signal, a horizontal synchronizing signal, and a communication signal for controlling the image taking unit from the image generation unit 12 at timings according to information about the exposure time included in the communication signal for controlling the image taking unit.

Specifically, if interlaced scanning is performed, the readout scanning counter 54c starts to count up the line number when the exposure time (count width, e.g., width corresponding to W) has elapsed since the start of counting up of the reset scanning counter 54a, on the basis of information about the exposure time, step width W, and the scanning line number M (=1) included in the communication signal for controlling the image taking unit sent from the image generation unit 12. The readout scanning counter 54c counts up the line number starting with the initial value in increments of W and outputs each counted value (including the initial value) to the read scanning address decoder 54d.

In contrast, if interlaced scanning is not performed, the readout scanning counter 54c starts to count up lines when an exposure time (count width) has elapsed, sequentially counts up lines starting with the initial value in increments of one, and outputs each counted value to the read scanning address decoder 54d.

The read scanning address decoder 54d generates a readout line selection signal for selecting and enabling, as a “readout line L,” a line with the line number outputted from the readout scanning counter 54c and outputs the generated readout line selection signal to the sensor cell array 56. As a result, only the selection line is enabled and other lines are disabled.

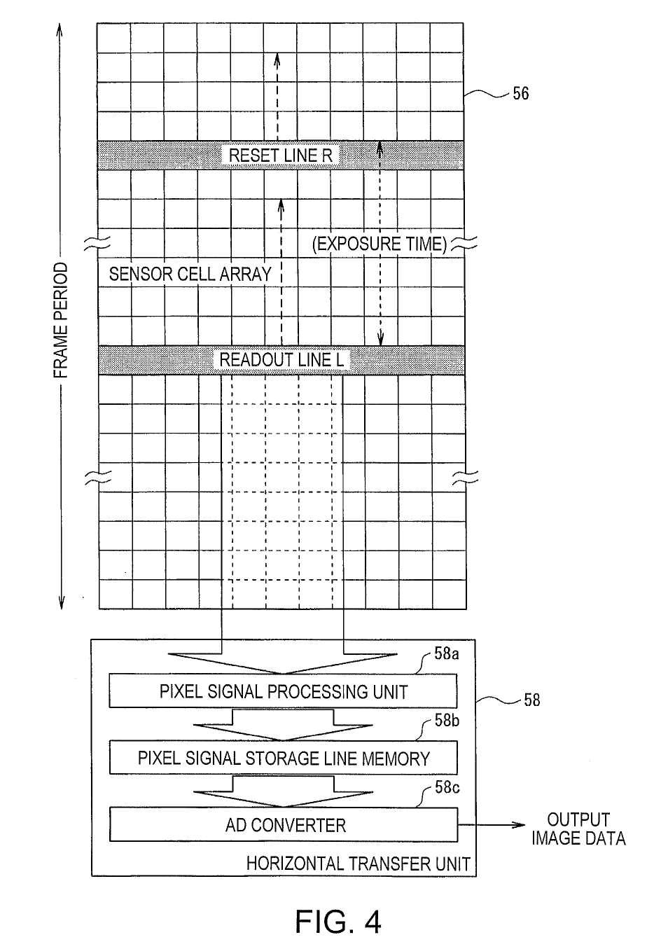

Referring now to FIG. 4, a method for controlling the exposure time of the image taking unit 11 and a method for reading pixel signals from the sensor cell array 56 will be described in details. FIG. 4 is a diagram showing an example of exposure of pixels and reading of pixel signals from pixels on a line-by-line basis in the light receiving area of the sensor cell array 56 included in the image taking unit 11.

As shown in FIG. 4, the exposure time is controlled by, first, sequentially enabling, as reset lines R, lines corresponding to reset line selection signals inputted one after another from the scanning line scanner 54 in one frame period and, then, performing reset processes on the enabled lines. When exposure times (count width) set for these lines have elapsed after the reset processes, these lines sequentially receive readout line selection signals from the scanning line scanner 54 and then are enabled as readout lines L. Then, pixel signals are read from the enabled lines.

Pixel signal data read from each readout line L is transferred to the image generation unit 12 by the horizontal transfer unit 58. As shown in FIG. 4, the horizontal transfer unit 58 includes a pixel signal processing unit 58a, a pixel signal storage line memory 58b, and an AD converter 58c.

The pixel signal processing unit 58a performs processes such as signal level adjustment on pixel signal data read from each readout line L and then stores the resultant data in the pixel signal storage line memory 58b on a line-by-line basis. Also, the stored pixel signal data is converted into digital data (hereafter referred to as “pixel data”) by the AD converter 58c and the resultant pixel data is outputted to the image generation unit 12 in serial on a line-by-line basis.

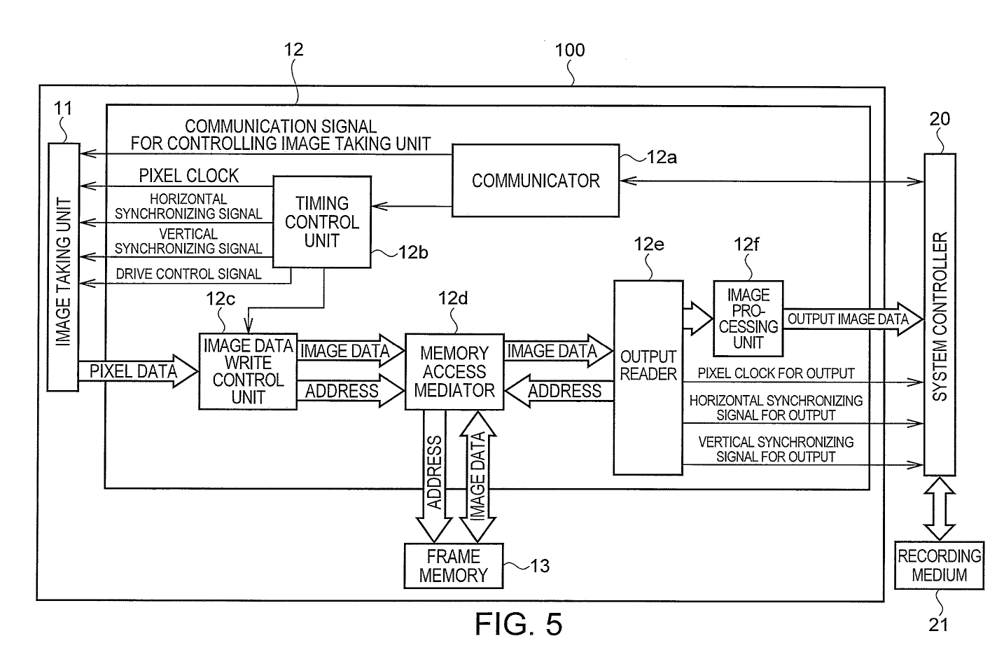

Referring now to FIG. 5, an internal configuration of the image generation unit 12 will be described. FIG. 5 is a block diagram showing an internal configuration of the image generation unit 12. As shown in FIG. 5, the image generation unit 12 includes a communicator 12a, a timing control unit 12b, a pixel data write control unit 12c, a memory access mediator 12d, an output reader 12e, and an image processing unit 12f.

The communicator 12a transmits, to the image taking unit 11, a communication signal for controlling the image taking unit, including information about the exposure time and information about interlaced scanning such as information whether interlaced scanning is performed, the step width W in a case where interlaced scanning is performed, and the scanning line number M. Also, the communicator 12a outputs, to the timing control unit 12b, a drive control signal for controlling operations of the timing control unit 12b in accordance with the above-mentioned command from the system controller 20.

The timing control unit 12b generates signals such as a pixel clock, a horizontal synchronizing signal (HSYNC), and a vertical synchronizing signal (VSYNC) on the basis of a reference clock from a reference clock generator (not shown) and outputs the generated signals to the image taking unit 11 and pixel data write control unit 12c.

The pixel data write control unit 12c receives pieces of pixel data from the image taking unit 11, as well as generates the addresses of the pieces of pixel data on the basis of the pixel clock, horizontal synchronizing signal, and vertical synchronizing signal from the timing control unit 12b and outputs the pieces of pixel data and addresses thereof to the memory access mediator 12d together with a write command in such a manner that the pieces of pixel data and corresponding addresses are combined.

In accordance with commands for reading or writing data from or into the frame memory 13 transmitted from the pixel data write control unit 12c and output reader 12e, the memory access mediator 12d mediates requests for accessing image data stored in the frame memory 13 from these two systems and accesses the frame memory 13.

Specifically, when the memory access mediator 12d receives a pixel data write command from the pixel data write control unit 12c, it outputs a request for writing pixel data into a specified address, to the frame memory 13. When the memory access mediator 12d receives a pixel data read command from the output reader 12e, it outputs a request for reading pixel data from a specified address, to the frame memory 13.

In synchronization with synchronizing signals for output (a pixel clock for output, a horizontal synchronizing signal for output, and a vertical synchronizing signal for output), the output reader 12e outputs image data obtained from the frame memory 13 via the memory access mediator 12d, to the image processing unit 12f.

Specifically, first, the output reader 12e outputs a command for reading image data, to the memory access mediator 12d. Then, the output reader 12e obtains image data via the memory access mediator 12d and outputs the obtained image data to the image processing unit 12f in synchronization with a synchronizing signal for output. Also, the output reader 12e counts a pixel number (address) to be read, on the basis of various synchronizing signals and outputs the counted pixel number to the memory access mediator 12d.

The image processing unit 12f performs image processing such as color balance adjustment, black level adjustment, and y correction on image data from the output reader 12e and outputs the resultant image data to the system controller 20 in synchronization with a synchronizing signal for output.

Incidentally, if the frame memory 13 receives a readout request from the memory access mediator 12d, it reads image data stored in an area having an address indicated by the request. In contrast, if the frame memory 13 receives a write request from the memory access mediator 12d, it writes the received data into an area with an address indicated by the write request.

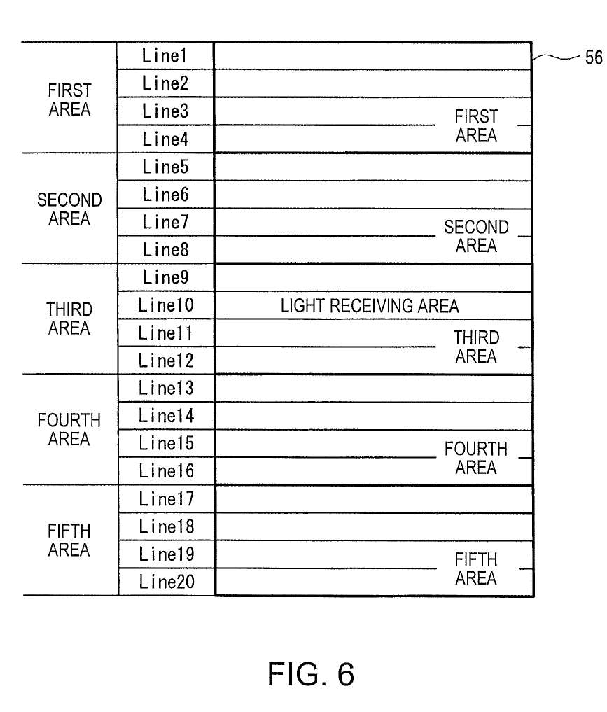

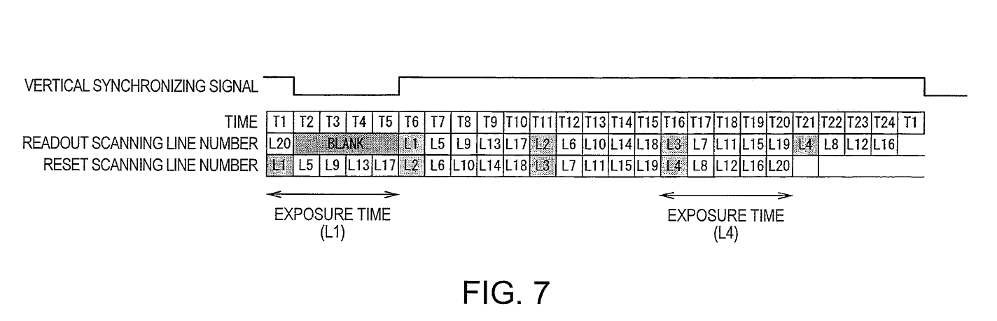

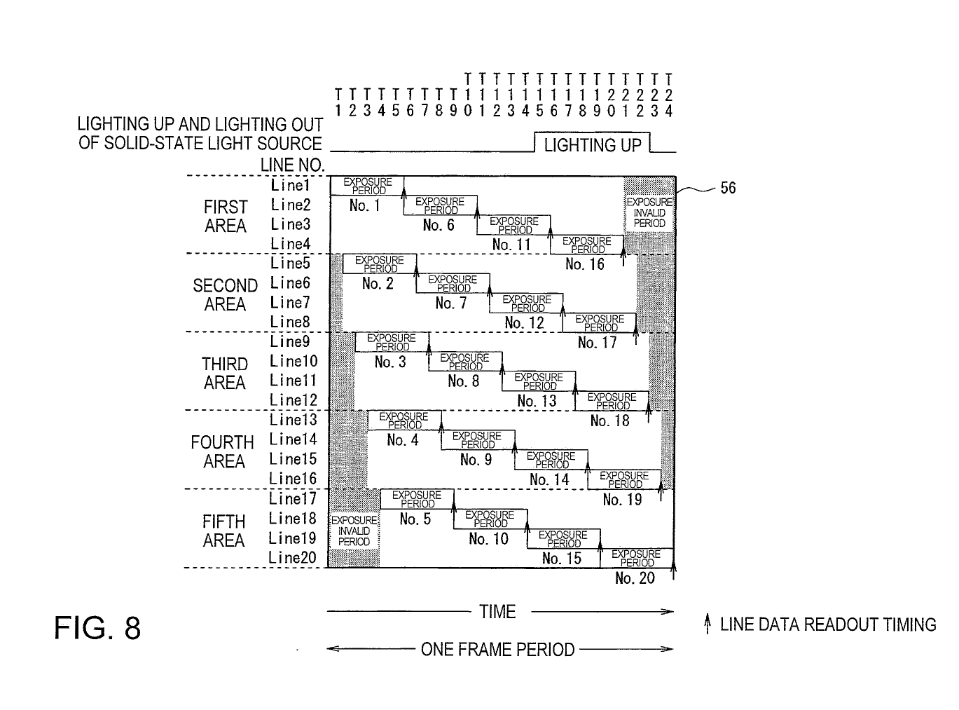

Referring now to FIGS. 6 to 8, a reset operation and a pixel signal readout operation performed during interlaced scanning will be described using a specific example. FIG. 6 is a diagram showing an example in which a light receiving area is logically divided. FIG. 7 is a diagram showing an example of reset timings and pixel signal readout timings during interlaced scanning. FIG. 8 is a diagram showing the relations between the exposure times and pixel signal readout timings in one frame period during interlaced scanning.

Here, assume that the total number FL of lines included in the light receiving area is “20,” for convenience sake. Also, assume that lines including pixels in the light receiving area are represented by Lines 1 to 20 (each ending number corresponds to each line number) in descending order and that the lines are cyclically scanned in the scanning order of Line 1→Line 2 . . . Line 20→Line 1.

First, the system controller 20 determines whether interlaced scanning should be performed, on the basis of image data obtained under the current image taking environment, the condition under which an image of a subject has been taken, and the like.

For example, the system controller 20 determines the exposure time Ts suited to taking an image of a subject on the basis of image data obtained under the current environment, for example, by adjusting the brightness range so that the brightness range falls within a specific range. Then, if the determined exposure time TS is less than half of one frame period Tf, the system controller 20 determines that interlaced scanning should be performed. If not so, the system controller 20 determines that interlaced scanning need not be performed (that is, normal scanning will be performed).

If the system controller 20 determines that interlaced scanning should be performed, it determines the number of division of the light receiving area on the basis of the exposure time Ts. In this case, the division number is determined on the basis of a result of division of one frame period Tf by the exposure time Ts. Here, the exposure time Ts is one-fourth one frame period Tf (Ts=Tf/4) and therefore the division result is four. This division result is regarded as the width of each area and, from the value of the width, a logical division number “5” is determined.

As a result, the light receiving area is logically divided into five areas and the width of each area (step width W) is calculated as “4.” Thus, as shown in FIG. 6, the light receiving area is divided into five uniform logical areas each having a width of four lines, that is, first to fifth areas.

The system controller 20 outputs, to the communicator 12a, a command including information about the exposure time Ts and information about interlaced scanning, including a interlaced-scanning flag (here, “1” since interlaced scanning is performed (“0” if interlaced scanning is not performed)), a step width “4,” and the scanning line number “1.”

The communicator 12a generates a communication signal for controlling the image taking unit, including the information about the exposure time Ts and information about interlaced scanning on the basis of the command from the system controller 20 and outputs the generated communication signal to the image taking unit 11.

Upon receipt of the communication signal for controlling the image taking unit, the image taking unit 11 writes the information about the exposure time Ts and information about interlaced scanning included in the signal into an internal register.

The reset scanning counter 54a of the scanning line scanner 54 performs a counting-up operation in which counting up is performed starting with an initial value “1” in increments of four, on the basis of the information about interlaced scanning written into the register. Also, the reset scanning address decoder 54b generates a reset line selection signal one after another with respect to each counted value and outputs the generated reset line selection signal to the sensor cell array 56 so as to enable a line on which a reset process is to be performed.

Also, the readout scanning counter 54c of the scanning line scanner 54 starts to perform a counting-up operation starting with an initial value “1” in increments of four when the exposure time Ts has elapsed after start of counting up of the reset scanning counter 54a, on the basis of information about the exposure time Ts written into the register. Also, the read scanning address decoder 54d generates a readout line selection signal one after another for each counted value and outputs the generated readout line selection signal to the sensor cell array 56 so as to enable a line on which a readout process is to be performed.

The sensor cell array 56 successively performs an accumulated-electric-charge reset process or a pixel signal readout process on the enabled selection line. As shown in FIG. 7, first, the sensor cell array 56 sequentially resets the accumulated electrical charge of Line 1 (first area), Line 5 (second area), Line 9 (third area), Line 13 (fourth area), and Line L7 (fifth area) during a period from T1 to T5 in accordance with the above-mentioned interlaced scanning and then reads (transfers) a pixel signal from Line 1 at time T6.

Specifically, a line in a different area is reset at each time such as resetting Line 1 in the first area at time T1, Line 5 in the second area at time T2, Line 9 in the third area at time T3, . . . . Similarly, pixel signals are read from lines. With regard to Line 1, after a BLANK period (corresponding to the exposure time) from the reset at T1 until T5, a pixel signal is read therefrom at time T6. Also, at time T6, accumulated electrical charge of Line 2 is reset.

Similarly, at times T7 to T20, Lines 6, 10, 14, 18, . . . , 8, 12, 16, and 20 are sequentially reset. Along with this, pixel signals are read sequentially from Lines 5, 9, 13, 17, . . . , 7, 11, 15, and 19. Since there is a phase difference corresponding to a BLANK period between a reset operation and a read operation, pixel signals are continuously read from Lines 4, 8, 12, 17, and 16 in this order at times T21 to T24.

The period from T1 to T24 constitutes one frame period.

FIG. 8 shows exposure timings and reading timings in reset processes and readout processes in a case where interlaced scanning is performed on Lines 1 to 20 in one frame period.

Specifically, by performing interlaced scanning, the exposure times of the lines in each of the first to fifth areas approximately cover one frame period. Thus, even if a flashing solid-state light source as a subject lights up and out at timings shown in FIG. 8, exposure periods Nos. 11, 16, 12, 17, 13, 18, 14, 19, 15, and 20 in the first to fifth periods overlap a period during which the solid-state light source is lighting up. As a result, images of the solid-state light source in a lighting-up state are taken accurately in lines corresponding to these exposure periods.

While an example in which the number of lines is extremely small, e.g., 20 is shown in FIG. 8, recent digital cameras and the like have several million to over 10 million pixels and much more lines than those in this example. Therefore, if an image of a flashing subject (e.g., LED traffic signal, etc.) is taken, the light receiving area is covered almost entirely unless the light source of the subject is extremely small.

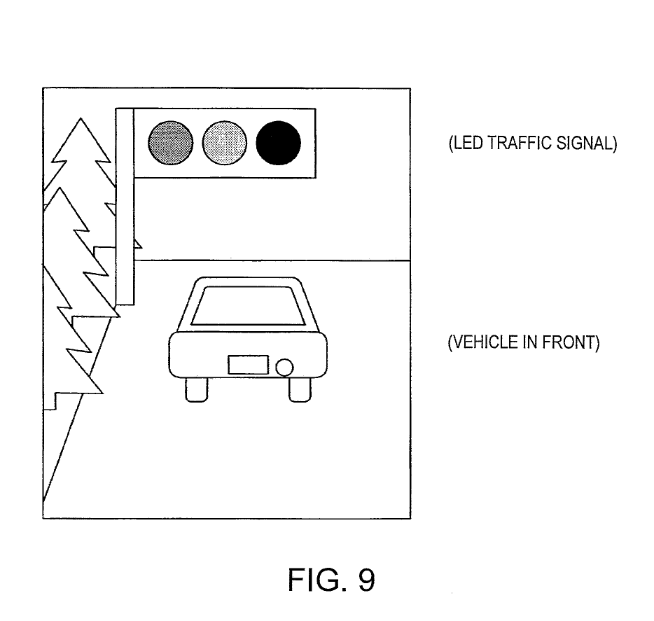

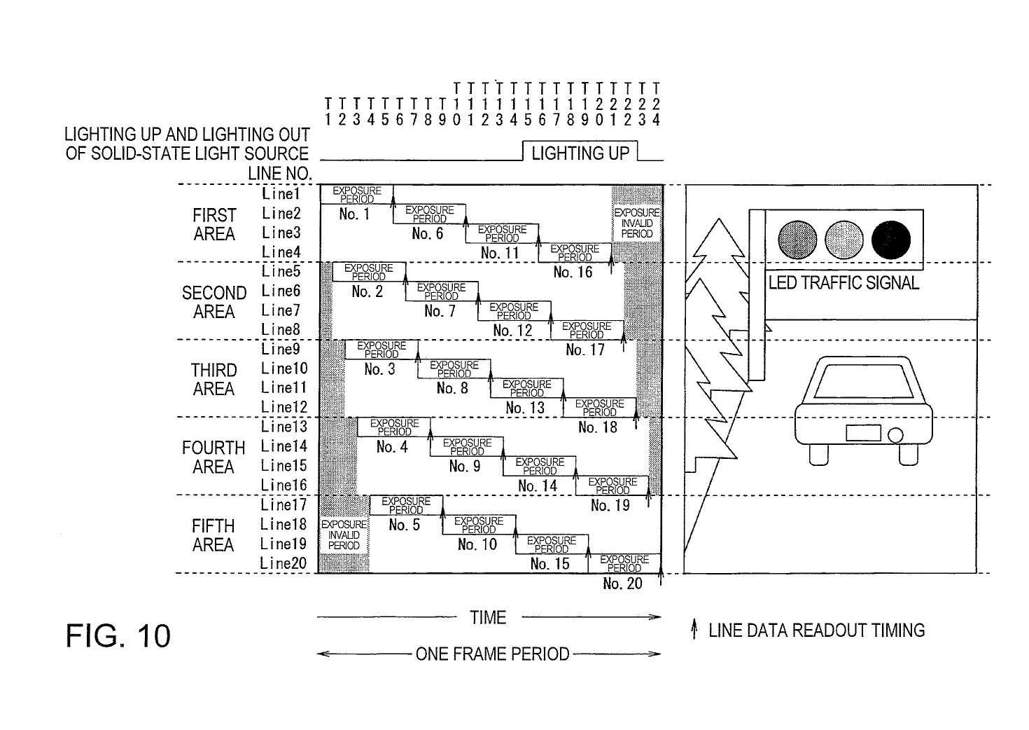

Referring now to FIGS. 9 and 10, actual operations performed when the image taking system 1 according to this embodiment is mounted on an automobile will be described.

FIG. 9 is a drawing showing an example of a taken image. FIG. 10 is a diagram showing an example of exposure timings and read timings in a case where interlaced scanning is performed on the image shown in FIG. 9.

Here, assume that the image taking unit 11 of an image recorder 100 is mounted on the automobile so that an image of a subject included in a range (including the height range of a traffic signal) in front of the automobile is taken. Also, assume that the image taking system 1 is mounted on the automobile so that the image taking system 1 collaborates with a car navigation system mounted on the automobile and that the image taking system 1 and car navigation system are coupled to each other so as to communicate data to each other.

Also, assume that the total number FL of lines in the light receiving area of the sensor cell array 56 is “20” as described above. When the engine of the automobile on which the image taking system 1 is mounted is started and the car navigation system, image recorder 100, and host system 200 are powered on, the image recorder 100 performs a start operation and then starts to take images of a subject lying in front of the automobile using the image taking apparatus 10. In this embodiment, the image taking apparatus 10 performs counting operations for normal scanning using the scanning line scanner 54 in accordance with the initial settings in a period immediately after starting to take an image of an object.

Pixel data generated from the taken image is stored in the frame memory 13 via the memory access mediator 12d by the pixel data write control unit 12c of the image generation unit 12. Also, the image data stored in the frame memory 13 is read via the memory access mediator 12d by the output reader 12e and outputted to the image processing unit 12f. Then, the read image data is subjected to various types of image processing by the image processing unit 12f and outputted to the system controller 20 in synchronization with a synchronizing signal for output.

Subsequently, the system controller 20 determines the exposure time Ts suitable for taking an image of the subject on the basis of the above-mentioned image data.

As described above, if the determined exposure time Ts is less than half of one frame period Tf, the system controller 20 determines that interlaced scanning should be performed. If not so, the system controller 20 determines that interlaced scanning need not be performed.

Here, assume that the current environment is outdoors where sunlight beats down and that the exposure time is short (less than one-half). Accordingly, it is determined that interlaced scanning will be performed.

Also, the division number N and the step width W are determined on the basis of a result of division of one frame period TF by the exposure time Ts. Here, the exposure time Ts is one-fourth one frame period Tf (TS=Tf/4). Accordingly, since the division value is “4,” the step width becomes “4” and the area division number becomes “5.”

Since the image taking unit 11 employs sub-pixel type as the color filter array type as described above, the number of scanning lines is “1.”

Subsequently, the system controller 20 generates a command including information about the exposure time Ts and information about interlaced scanning, including an interlaced scanning flag “1,” a step width “4”, and a scanning line number “1,” and outputs the generated command to the communicator 12a of the image generation unit 12.

In the image generation unit 12, the communicator 12a generates a communication signal for controlling the image taking unit, including information about the exposure time Ts and information about interlaced scanning, in accordance with the command from the system controller 20 and outputs the generated signal to the image taking unit 11 so that various types of information is written into a register of the image taking unit 11.

Also, the communicator 12a generates a drive control signal on the basis of the command from the system controller 20 and outputs the generated signal to the timing control unit 12b.

The timing control unit 12b always generates a pixel clock, a vertical synchronizing signal, and a horizontal synchronizing signal in accordance with a reference clock and outputs these signals to the image taking unit 11.

Also, the timing control unit 12b outputs a control signal for giving an instruction, such as one for starting or stopping taking an image, to the image taking unit 11 in accordance with the drive control signal from the communicator 12a.

Upon receipt of an instruction for starting to take an image, the image taking unit 11 performs interlaced scanning as shown in FIGS. 7 and 8 so as to take an image of a subject lying in front of the automobile.

Here, assume that a subject including a flashing LED traffic signal has appeared, as shown in FIG. 9.

The image taking unit 11 takes an image of this subject while performing interlaced scanning. As shown in FIG. 10, an image of the light-emitting part of the traffic signal is taken in the first area that is the highest one of the logically divided five areas.

As shown in FIG. 10, the traffic signal lights out during the first 50 to about 60% of one frame period and subsequently lights up. Therefore, in exposure period No. 6, an image of the upper part of the light-emitting part is taken in Line 2. Then, in exposure periods Nos. 11 and 16, an image of the remaining part of the light-emitting part is taken.

Pixel data generated from the taken images is stored as image data in the frame memory 13 by the image generation unit 12. The stored image data is outputted to the image processing unit 12f by the output reader 12e. The image data is subjected to various types of image processing by the image processing unit 12f. The resultant image data is outputted to the system controller 20.

The system controller 20 records image data sent from the image generation unit 12 in the recording medium 21, as well as outputs the image data to a display unit (with a touch panel) of the car navigation system so as to display an image.

Also, the system controller 20 outputs image data (image data) over multiple frames recorded in the recording medium 21, to the host system 200.

The host system 200 analyzes the image data from the system controller 20. Then, the host system 200 determines that an image of the traffic signal has been taken in the first area, as well as determines the state of the traffic signal whose image has been taken.

As shown in FIG. 10, the flashing traffic signal is lighting up in the latter half of exposure period No. 11 and in exposure period No. 16. As a result, the traffic signal is lighting out in an image taken by Line 2 in the first area; it is emitting light-(lighting up) in images taken in Lines 3 and 4 therein.

According to this embodiment, if an image of the traffic signal that is emitting light has been taken by only one line, the host system 200 determines that the traffic signal is emitting light. Therefore, from the fact that the traffic signal is emitting light in images taken in two lines, the host system 200 determines that the traffic signal is emitting light and then determines with what color the traffic signal is emitting light. The determination of color may be made on the basis of color information obtained from sub-pixels or on the basis of the light-emitting position of the traffic signal. If the determination of color is made on the basis of color information and if a different luminance is shown for each line at the red light emitting position, it is determined that the traffic signal is lighting up with red color.

On the basis of results of the determinations of the light-emitting state of the traffic signal, the traveling speed of the automobile, and the like, the host system 200 may instruct the system controller 20 to output a warning sound or a warning message. For example, if the host system 200 determines that the traffic signal is emitting red or yellow light and also determines that the traveling speed of the automobile is higher than a comparative value, it instructs the system controller 20 to output a warning sound or a warning message.

The system controller 20 causes the sound output unit 22 to output a sound on the basis of sound data previously prepared in a storage medium (not shown) in accordance with a sound output instruction from the host system 200.

Also, by touching the display position of a particular subject (e.g., LED traffic signal, etc.) among subjects displayed on a touch panel, a result of an analysis (e.g., light-emitting state of the traffic signal) performed by the host system 200 on the particular subject may be displayed or outputted as a sound.

While the respective exposure periods of the lines in each area are prevented from overlapping one another in the example shown in FIG. 10, the exposure periods may be overlapped by one another by controlling scan timings (exposure timings) to reduce the reset intervals between the lines in each area. In contrast, the reset intervals between the lines in each area may be increased so that the exposure periods are distributed over a wider part of one frame period.

As described above, the image taking system 1 according to this embodiment is allowed to perform interlaced scanning in which the light receiving area of the sensor cell array 56 is logically divided into the N-number of uniform areas including lines having pixels and the divided light receiving areas are scanned by M lines starting with the first line in each area while changing an area to be scanned to another area each time M lines are scanned.

As a result, the exposure periods of the lines are distributed over almost all parts of one frame period in each of the divided areas. Thus, an image of the solid-state light source that light up and lights out in one frame period is taken accurately (so that the solid-state light source in a lighting-up state is recognized).

In the above-mentioned first embodiment, the image taking unit 11 and system controller 20 correspond to the image sensor according to the first aspect of the invention. The image taking apparatus 10 and system controller 20 correspond to the image taking apparatus according to the first aspect of the invention. The image recorder 100 corresponds to the image recorder according to the second aspect of the invention.

In the above-mentioned first embodiment, the function of the system controller 20 for dividing the light receiving area of the sensor cell array 56 into the N number of logic areas corresponds to the area division unit according to the first aspect of the invention. The scanning line scanner 54 of the image taking unit 11 corresponds to the interlaced scanning unit according to the first aspect of the invention. The function of the sensor cell array 56 for reading pixel signals from lines including pixels on the basis of a readout line selection signal corresponds to the pixel signal readout unit according to the first aspect of the invention.

Also, in the above-mentioned first embodiment, the image generation unit 12 corresponds to the image data generation unit according to the first aspect of the invention. The frame memory 13 corresponds to the image data storage unit according to the first aspect of the invention.

Also, in the above-mentioned first embodiment, the storage medium 21 corresponds to the image recording unit according to the first aspect of the invention. The function of the system controller 20 for outputting the image data stored in the storage medium 21 to the host system 200 corresponds to the image data output unit according to the first aspect of the invention.

### Second Embodiment

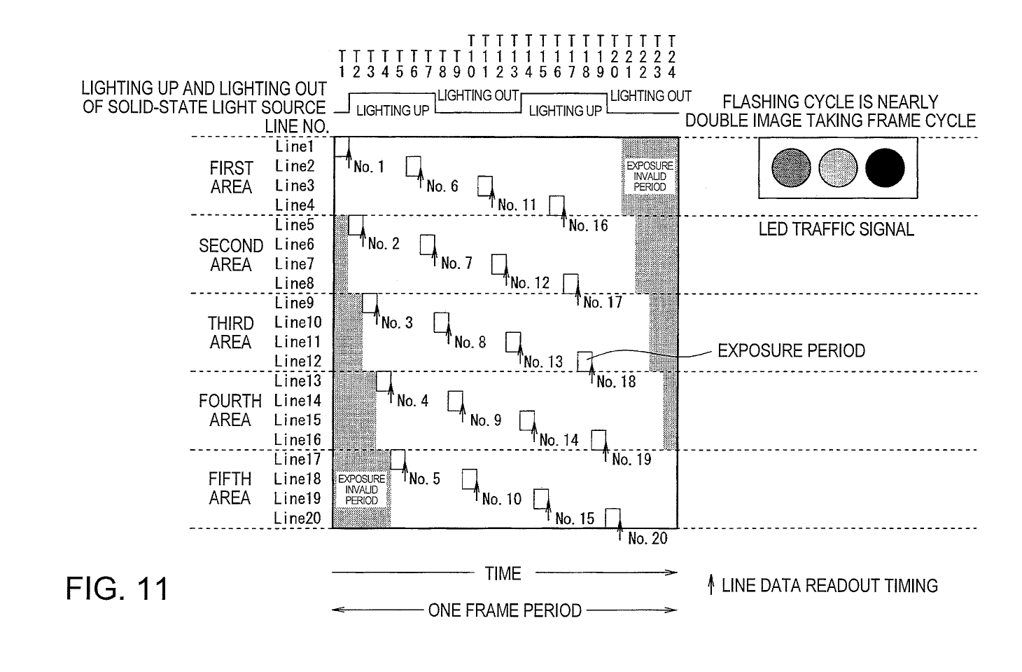

Hereafter, an image taking apparatus and an image recorder according to a second embodiment of the invention will be described with reference to the accompanying drawings. FIG. 11 is a diagram showing the image taking apparatus and image recorder according to this embodiment.

The configuration of an image taking system according to this embodiment is similar to that of the image taking system 1 according to the above-mentioned first embodiment except that a method for dividing the light receiving area according to this embodiment is different from that according to the first embodiment.

The area division method according to this embodiment is suitable for a case where the exposure time is extremely small (e.g., a case where the division area number is small, e.g., 2 or 3, in the first embodiment), information about the flashing cycle of a flashing light source is known, and the time during which the light source lights up is equal to or longer than the time during which it lights out.

Referring now to FIG. 11, the area division method according to this embodiment will be described in detail, FIG. 11 is a diagram showing relations between exposure periods and pixel signal readout timings in one frame period in a case where interlaced scanning is performed using the area division method according to this embodiment.

For example, the exposure time becomes the shortest exposure time (extremely short) allowable for the image taking apparatus 10 in a scene such as outdoors, fine weather, or backlight. If interlaced scanning is performed using the area division method according to the first embodiment, an image of a flashing solid-state light source in a lighting-up state may not be taken accurately.

For example, as shown in FIG. 11, if the exposure time Ts is one-twentieth the frame period Tf (Tf/20) and if the area division method according to the first embodiment is used, the division value (that is, width) becomes 20. Accordingly, the number of areas becomes one. In other words, the light receiving area cannot be divided into multiple areas. This makes it difficult to cope with a flashing light source.

On the other hand, in the area division method according to this embodiment, the number of areas into which the light receiving area is divided is determined on the basis of information about a subject (information about the flashing cycle of a solid-state light source). Specifically, the area division number and area width (step width W) are determined on the basis of a sampling theorem (if a sampling rate is double or more the band width of a light source of a traffic signal, there is no loss of information). That is, the sampling cycle (the cycle in which a pixel signal is read) of each area is set to half or less the flashing cycle TL.

Here, the total number of lines in the sensor cell array 56 is represented by Ln and the sampling cycle in a case where area division is not performed is represented by “Tf/Ln.” Since interlaced scanning is performed, the sampling cycle in each area is obtained as “N×Tf/Ln” by multiplying “Tf/Ln” by the area division number N. It is sufficient that the obtained “N×Tf/Ln” meets the sampling theorem. Therefore, Formula 1 below is established.

N×Tf/Ln≧TL/2 Formula 1

Formula 2 below is derived from Formula 1.

N≧0.5×Ln×TL/Tf Formula 2

Since the total line number Ln is 20 and “TL/Tf” is 0.5 in the example shown in FIG. 11, the system controller 20 calculates “0.5×20×0.5=5” in accordance with Formula 2 above. From the calculation result, the division number N is set to five. Also, since the total line number 20 is divided by 5 uniformly, the step width becomes “4.”

As a result, the light receiving area is divided into five uniform logic areas each having a width of four lines, that is, the first to fifth areas.

The system controller 20 outputs, to the communicator 12a, a command including information about the exposure time Ts (=Tf/20) and information about interlaced scanning, including an interlaced scanning flag “1,” a step width “4,” and a scanning line number “1” (it is assumed that sub-pixel type is employed in this embodiment).

The communicator 12a generates a communication signal for controlling the image taking unit, including the information about the exposure time Ts and information about interlaced scanning, on the basis of the command from the system controller 20 and outputs the generated signal to the image taking unit 11. Thus, in the image taking unit 11, interlaced scanning is performed as shown in FIG. 11 so that pixel signals are read from each scan line.

If an image of a flashing LED traffic signal is taken in the first area as shown in the example shown in FIG. 11, the exposure time No. 6 overlaps a period during which the LED traffic signal is lighting up. Accordingly, an image of the LED traffic signal in a lighting-up state is accurately taken by a line corresponding to this exposure period.

As described above, if the image taking system 1 according to this embodiment is used in a case where the cycle of the flashing light source is known, the number of areas into which the light receiving area is divided is set using an area division method based on information about the flashing cycle of a subject and the sampling theorem even if the exposure time becomes extremely short under an environment such as outdoors in fine weather. Therefore, an image of the solid-state light source in a light-up state is taken almost accurately. Also, the area division number is set without depending on the exposure time.

In the above-mentioned second embodiment, the function of the system controller 20 for dividing the light receiving area of the sensor cell array 56 into the N number of logic areas uniformly on the basis of the sampling theorem corresponds to the area division unit according to the first aspect of the invention.

In the first embodiment, an example in which the area division number and step width are determined on the basis of a result of division of one frame period by the exposure time is described. In the second embodiment, the area division number and step width are determined on the basis of the sampling theorem in a case where the flashing cycle of a flashing subject is previously known. However, without being limited to these methods, the area division number and step width may be determined using any other methods.

What is claimed is:

1. An image taking apparatus comprising:
a photoelectric conversion unit including a plurality of photoelectric conversion elements, the photoelectric conversion elements being disposed in a two-dimensional matrix, converting received light into electric charge and accumulating the electric charge;
an image sensor having a function of controlling an exposure time of each of the photoelectric conversion elements on a line-by-line basis;
an area division unit for logically dividing the photoelectric conversion unit into an N number of uniform areas on the basis of information related to a taken image of a subject, each of the uniform areas including a line having some of the photoelectric conversion elements, N being a natural number of two or more;
an interlaced scanning unit for scanning the photoelectric conversion elements in the first to N-th areas by M lines starting with a predetermined line in a predetermined area of the first to N-th areas in each frame while changing an area to be scanned to another area in a predetermined order each time the M lines are scanned, M being a natural number of one or more; and
a pixel signal reading unit for reading, from each of the photoelectric conversion elements scanned by the interlaced scanning unit, a pixel signal including an electric signal corresponding to an amount of electric charge accumulated in each photoelectric conversion element.

2. The image taking apparatus according to claim 1, further comprising
a normal scanning unit for sequentially scanning the photoelectric conversion elements by the M lines, wherein
if the exposure time of the line is less than half the frame period, the area division unit logically divides the photoelectric conversion unit into the N number of areas and the interlaced scanning unit scans the photoelectric conversion elements, and
if the exposure time of the line is half or more the frame period, the normal scanning unit scans the photoelectric conversion elements and the pixel signal reading unit reads the pixel signal from each of the photoelectric conversion elements scanned by the normal scanning unit.

3. The image taking apparatus according to claim 1, wherein
the area division unit logically divides the photoelectric conversion unit into the N number of areas on the basis of a result of division of the frame period by the exposure time of the line.

4. The image taking apparatus according to claim 1, further comprising
a cycle information acquisition unit for acquiring information about a cycle of lighting up and lighting out of a subject, the subject emitting light while lighting up and lighting out cyclically, wherein
if an image taking target includes the subject, the area division unit logically divides the photoelectric conversion unit into the N number of areas on the basis of the cycle information acquired by the cycle information acquisition unit.

5. The image taking apparatus according to claim 4, wherein
the area division unit logically divides the photoelectric conversion unit into the N number of areas on the basis of a result obtained by: dividing a cycle time of lighting up and lighting out of the subject, by a time giving a cycle of a frame; multiplying a result of the division by a total number of lines included in the photoelectric conversion unit; and dividing a result of the multiplication by two.

6. The image taking apparatus according to claim 1, further comprising:
an image data generation unit for generating image data on the basis of a pixel signal read by the pixel signal reading unit; and
an image data storage unit for storing the image data.

7. An image recorder comprising:
the image taking apparatus according to claim 1;
an image recording unit recording image data over a plurality of continuous frames, the image data being obtained by taking an image of a subject using the image taking apparatus; and
an image data output unit for outputting the image data recorded in the image recording unit.
